(19) United States
(12) Patent Application Publication
(10) Pub. No.: US 2006/0239757 A1
(43) Pub. Date: Oct. 26, 2006

(54) Application and/or carrying devices for oral care compositions

(76) Inventor: Martin S. Giniger, New York, NY (US)

Correspondence Address: HENSLEY KIM & EDGINGTON, LLC, 1660 LINCOLN STREET, SUITE 3050, DENVER, CO, 80264, US

(21) Appl. No.: 11/355,923

(22) Filed: Feb. 15, 2006

Related U.S. Application Data
(60) Provisional application No. 60/653,421, filed on Feb. 15, 2005.
(60) Provisional application No. 60/734,549, filed on Nov. 7, 2005.
(60) Provisional application No. 60/734,477, filed on Nov. 7, 2005.
(60) Provisional application No. 60/739,902, filed on Nov. 26, 2005.

(51) Int. Cl. B43K 5/14; A45D 33/00; A46B 11/00

(52) U.S. Cl. 401/132; 401/130; 401/126

(57) ABSTRACT

A swab tube for use in oral care. The swab tube includes a swab pre-sealed within a tube which is adapted to contain an oral care composition.

### BACKGROUND

The present invention relates to improvements in oral care compositions and application and/or carrying devices therefor, and more particularly relates to a foam-tipped applicator and/or carrying device which may be pre-packaged with a fluid oral care composition.

In the state of the art of oral care compositions and the delivery of such compositions to the site of use in the oral cavity, many means and methods have been utilized and yet numerous issues remain. For an effective ingredient of an oral care composition to have a therapeutic effect, whether for oral cleaning, treatment, or tooth whitening, the effective ingredient must reach and maintain effective contact with the oral care feature long enough to provide its intended effect. Thus, delivery to and dispersion and penetration into and between the surfaces of various oral features such as the odd shapes of the nooks and crannies of adjacent teeth is a continual issue. So too then is the dwell or contact time necessary or at least preferred for having the effective ingredient or ingredients of an oral care composition maintained in contact with or otherwise disposed adjacent the surface of the oral feature being cared for. Such issues arise in various oral cleaning, treatment and/or tooth whitening situations.

In tooth cleaning and/or treatment, effective ingredients such as fluoride or an anti-gingival agent, e.g., triclosan, must reach the areas between teeth or between a tooth and gums and/or reach the nooks and crannies on/of teeth to provide their benefits to those oral features. Similar activities are necessary in tooth whitening as well. In considering tooth whitening generally, it may first be noted that a tooth is comprised of an inner dentin layer and an outer hard enamel layer that is the protective layer of the tooth. The enamel layer of a tooth is naturally an opaque white or slightly off-white color. It is this enamel layer that can become stained or discolored. The enamel layer of a tooth is composed of hydroxyapatite mineral crystals that create a somewhat porous surface. It is believed that this porous nature of the enamel layer is what allows staining agents and discoloring substances to permeate the enamel and discolor the tooth.

Many substances that a person ingests on a daily basis can “stain” or reduce the “whiteness” of one's teeth. In particular, foods, tobacco products, and fluids such as tea and coffee that one consumes tend to stain one's teeth. These products or substances tend to accumulate on the enamel layer of the teeth and form a pellicle film on the teeth. These staining and discoloring substances can then permeate the enamel layer. This problem occurs gradually over many years, but imparts a noticeable discoloration of the enamel of one's teeth.

Many different oral compositions for stain removal or tooth whitening are available to consumers and dentists for home and professional in-office use. Many of these compositions contain 1-45% by weight concentrations of a peroxygen compound such as hydrogen peroxide and, when applied on the teeth, may effect whitening of stains. These compositions all require different amounts of time to achieve a desired tooth bleaching effect. These times range from 90 to 120 minutes for a dentist-applied, light-activated bleaching system to two weeks or more of overnight exposure for consumer-applied, tray-delivered whitening products. Currently, even the top selling brands of dentist-applied, light-activated, chair-side tooth whitening systems require a minimum of three (3) twenty-minute applications and an overall minimum of ninety (90) minutes or more to complete when all manufacturers' instructions are followed.

Among the chemical strategies available for removing or bleaching tooth stains, the most effective compositions contain an oxidizing agent, usually a peroxygen compound such as hydrogen peroxide, in order to attack the chromogen molecules forming the stains in such a way as to render them colorless, water-soluble, or both. In one of the most popular approaches to whitening a patient's teeth, a dental professional will construct a custom-made, tooth-bleaching tray for the patient from an impression made of the patient's dentition. A prescription oxidizing gel is dispensed into the tooth-bleaching tray and worn intermittently over a period of time ranging from about 2 weeks to about 6 months, depending upon the severity of tooth staining. These oxidizing compositions, usually packaged in small plastic syringes are dispensed directly by the patient into the custom-made, tooth-bleaching tray and are held in place in the mouth for typical contact times of greater than about 60 minutes, and sometimes as long as 8 to 12 hours. The slow rate of bleaching is in large part due to the nature of the formulations developed to maintain stability of the oxidizing composition.

Alternatively, some oxidizing compositions with relatively high concentrations of oxidizers are applied directly to the tooth surface of a patient in a dental office setting under the supervision of a dentist or dental hygienist. Supervision of application is required with the high concentration oxidizers because of the potential for damage to gums and other oral tissue from the misapplication of highly concentrated oxidizers. Theoretically, such tooth whitening strategies have the advantage of yielding faster results and better overall patient satisfaction.

Oral compositions for whitening teeth are also available containing peracetic acid dissolved or suspended in a vehicle. The peracetic acid may be generated within a dentifrice vehicle by combining water, acetylsalicylic acid, and a water soluble alkali metal percarbonate. Formulations for oxygen liberating compositions for the whitening of teeth also use either anhydrous and/or hydrated pastes or gels. Hydrated examples include an aqueous oral gel composition comprising about 0.5% to about 10% by weight urea peroxide and 0.01% to 2% by weight of a fluoride compound, and/or a water containing a hydrogen peroxide-Pluronic thickened oral gel composition. Other examples of whitening or stain removal compounds include toothpastes containing a combination of calcium peroxide and sodium perborate oxidizing agents, dicalcium phosphate, calcium carbonate and magnesium carbonate cleaning agents, sorbitol humectant, cornstarch and cellulose gum thickening agents, and an anionic detergent. Oral compositions containing peroxyacids and alkyl diperoxy acids having alkylene groups containing 5-11 carbon atoms are also used for removing stains from teeth.

Another conventional whitening technique is the administration of a light-activated gel under the supervision of a dentist using a protocol of a usual three (3) twenty minute applications. However, patients frequently become uncomfortable, agitated, and/or bored during such a procedure, which typically lasts between 1½ to 2 hours when all set-up and precautionary methods are included. Also, because of the length of exposure to both the gel and the light, teeth and oral tissues can become irritated or experience a transient hypersensitivity reaction. Thus, any improvement that results in decreased exposure time, increased patient comfort and increase in bleaching efficiency is desirable.

These extant methods are not quickly or highly effective and indeed need prolonged periods for any minimum effective bleaching effects. These time-consuming methods for teeth whitening thus suggest that any whitening system that can reduce the time factor is desirable.

Moreover, extant means for application and/or delivery of these and other oral care products such as these and other tooth whiteners may be less than desirable for a number of reasons, a minimum one of which being simplicity in the overall packaging of an applicator and the fluid composition to be delivered. Often these are separately packaged and not readily amenable to immediate application particularly by the user upon the user's own teeth. There is often difficulty in manipulation of the container of the oral care composition; particularly, when and during the simultaneous manipulation of a state-of-the-art applicator, such as a dental well and an associated dental brush, for “painting” the composition on the teeth.

These extant means are thus not quickly or highly effective. They may be time-consuming or merely difficult in manipulation; particularly for teeth whitening. They simply also be devices separately packaged from the whitening agent (pre-, post- or in-process whitening agent), and thereby requiring extra steps in moving the agent to the tray prior to use. Thus any oral care or whitening system for application of the composition that can reduce the time, complexity and/or difficulty factors is desirable.

Note, a swab tube for use in other than oral care has been known in which a cotton swab is pre-packaged in a sealed plastic tube with a personal care composition (such as a make-up composition); these are available from Innovative Swab Technologies, Inc., Antioch, Ill., USA, and representative patents include U.S. Pat. Nos. 4,952,204 and 6,406,451. Again, these have not been known for oral care composition use.

### SUMMARY OF THE INVENTION

A oral care foam-tipped device or swab-like applicator which may be pre-disposed in sealed tube with an oral care composition. The sealed tube may have a break open means to provide access to the device or applicator.

In one embodiment, the oral care composition may be an enhancing composition which may create an alkaline environment for activating peroxide whiteners and accelerating the formation of free radicals from the peroxide to effect the oxidation of organic molecules causing staining of the dentition. Such an enhancing composition may be used for advance application to the dentition before the application of any whitening compound. The primary components of such an enhancing composition are a solvent and a base compound. An exemplary solvent is water. One exemplary base that may be used is potassium hydroxide (KOH), which easily dissolves in water to form a strongly alkaline liquid. The dissolution of KOH in water also generates substantial heat, which may be conducive to the dissolution of additional ingredients in the enhancing composition. Other basic compounds may alternatively be used to create the alkalinity of the enhancing composition. A surfactant may also be included to clean the surfaces of the user's teeth in advance of application of the whitening composition. A peroxide may be added to the enhancing composition to provide tooth whitening. Other additives for taste, texture, viscosity, and other oral care or oral hygiene purposes may also be included in the enhancing composition. The enhancing composition may be used as part of a tooth whitening process to enhance the effect of a whitening composition. The enhancing composition is generally applied to a user's dentition in advance of a whitening or bleaching composition.

In addition, other oral care compositions may be used here including a rinse which may be used after the application of the whitening composition to neutralize the alkaline environment in the oral cavity caused by the enhancing composition and return the user's mouth to a neutral pH.

The foam of the swab-like tip preferably is of a polymer or polyester type which is resistant to degradation in the presence of the oral compositions described herein as well as any others which might be used herewith. In a variety of embodiments, the foam is of an open cell type, and in some embodiments has an inner resilient layer, and an outer softer layer. In some embodiments, the foam has an abrasive quality for breaking plaque and debris from the teeth. Other embodiments are described in further detail herein.

### BRIEF DESCRIPTION OF THE DRAWINGS

FIG. 1 is an isometric view of a self-contained swab unit employed herein, the enclosed swab being shown in dotted line;

FIG. 2 is an exploded isometric view showing the swab and sleeve of the assembly of which the unit of FIG. 1 is made;

FIG. 3 is an elevational, cross-sectional view of the unit of FIG. 1, with the sleeve shown in cross-section;

FIG. 4 is a flow diagram of an exemplary series of steps for using an oral care composition and swab unit hereof.

### DETAILED DESCRIPTION

The detailed description set forth herein is intended as a description of a swab and tube or sleeve system particularly as may be used with several exemplary compositions for enhancing the effectiveness of tooth whitening and/or other oral care compounds according to the present invention. These are not intended to represent the only forms in which such an oral care swab and tube hereof may be used, nor of how such compositions may be prepared or utilized. The description sets forth features of and steps for using the activator, enhancer, whitening, post-rinse or other oral care compositions of the present invention.

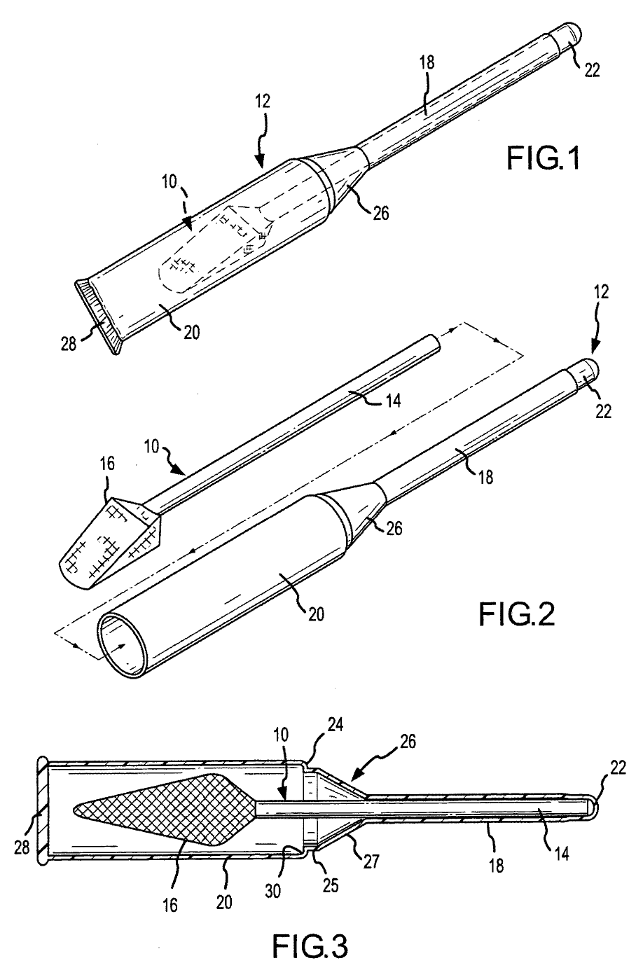

The swab and tube configuration hereof may be like that in U.S. Pat. No. 4,952,204, to Korteweg, with a principal difference in many embodiments being a foam tip. In more specifics, and turning in detail to FIGS. 1-3 of the appended drawings, therein illustrated is a self-contained swab unit embodying the invention. Here shown is a swab, generally designated by the numeral 10, and a sleeve or tube generally designated by the numeral 12. The swab 10 consists of a straight stick 14, usually of plastic, with a foam tip 16 attached on one end.

The sleeve 12 is of circular cross section and hollow along its length, and may be fabricated from a plastic material. It may include a relatively small diameter cylindrical handle portion 18 at one end, a substantially larger diameter receptacle portion 20 at the opposite end, and a transition portion 26 of compound configuration therebetween. The tip element 22 on the handle portion 18 has a diameter slightly reduced from that of the remainder of the handle portion, and may serve to frictionally engage the tip of the swab stick 14 inserted therein.

As will be appreciated from FIG. 2, the assembly may be produced simply by inserting the swab 10 into the sleeve 12 sufficiently to enable the tip element 22 to frictionally engage the stick 14, whereupon the foam tip 16 will reside within the enlarged receptacle portion 20. It will also be noted that the handle portion 18 conforms closely to the stick 14, in some instances of a frictional or force fit along the length or in some embodiments with a small gap between their confronting surfaces throughout most of their coextensive lengths. More of a gap may facilitate insertion of the swab. After the partial assembly of disposition of the swab stick into the sleeve, the sleeve will be at least partially filled in the receptacle portion with an oral care or tooth whitening composition as described below, following which the sleeve will be closed, such as by a heat seal 28, to produce a sanitary, in some cases sterile, integral unit.

Access to the swab is gained simply by squeezing or twisting or bending or otherwise manipulating the sleeve at the intersection between its receptacle and transition portions. The transition portion is uniquely configured to coact with the receptacle portion, so as to enable ready fracture under the influence of such force. In addition to affording access, this characteristic will provide a tamper-resisting feature to the package, since any loss of integrity will tend to be evident as cracking, crazing, or opacity at stress points.

As shown in FIG. 3, the transition portion consists, more particularly, of a narrow annular component 24, a short cylindrical component 25, and a frustoconical component 27, the latter merging into the handle portion 18. The annular component 24 in turn connects to the receptacle portion 20, with the adjacent components forming a sharp interior right angle intersection at 30. In some embodiments, the interior and exterior configurations together result in a minimum thickness of material at (or near) the intersection 30. Depending upon the nature of the material used to fabricate the sleeve, the stress created by compression (which arises because the adjacent components are incapable of assuming a compatible configuration upon flattening of the sleeve) will either cause it to snap at the intersection 30, or will at least crack or otherwise facilitate severance by a tearing action. The swab 10 may then be exposed for use upon removal from the receptacle portion.

The close conformity of the handle portion 18 of the sleeve to the stick 14 of the swab affords a secure and natural-feeling grip. The frustoconical component 26 of the transition portion, which remains after removal of the receptacle portion, may provide means for limiting the location at which the assembly can be grasped, and may thus help to prevent inadvertent touching of the area being treated, and yet may also serve to contain any of the substance that might drip, or run down the swab stick. In some instances for best results, it has been found that a sleeve having dimensions such as those typified hereinabove will be fabricated from polypropylene, in a thickness of about 0.3 millimeter. This may afford a level of rigidity that may provide good handling and structural features while, at the same time, tending to produce fracture upon manual compression at the frangible joint.

Manufacture of a tube hereof may follow one of those described in either of U.S. Pat. Nos. 4,952,204 or 6,406,451 or others which may provide for a sealed enclosure with a transition allowing for breaking and opening for use as described herein.

The swab tube assembly hereof may typically be employed for the application of liquids to the oral cavity whether for the teeth or oral mucosa or other surfaces, and/or for cleaning, medicinal, disinfectant, whitening or whitening related purposes, inter alia. As used herein, therefore, the term “applicator” is to be broadly construed to include, for example, use in any application of a composition to or for the benefit of the oral cavity or the elements thereof.

The range of sizes for the assembly and its components can also vary widely (e.g., the swab can be from about 3 to 15 centimeters in length (other lengths also being available), and the receptacle portion of the sleeve can be much longer or much shorter than the handle portion), as long as the wall thicknesses are controlled appropriately to afford the desired functional characteristics, as discussed herein. It may be preferred to provide sizing appropriate for a unit dose (i.e., a single use dose) of a particular oral care composition, and/or size appropriate for an applicator tip (e.g., a foam tip) which can adequately deliver an oral care composition (fluid, powder or like flowable or other material) to the desired oral feature, such as the teeth, thus typically sized appropriate for delivery to a tooth or teeth. For best results in functioning (at least when the sleeve is of about 0.3 millimeter thick polypropylene) that the component intersecting with the receptacle portion (e.g., the annular component 24 in the embodiment of FIGS. 1-5) be about 0.1-0.5 centimeter wide, to create adequate stress at the fracture point(s). The foam tip may be as much as 18 mm long (or longer or shorter), and may be about 5 mm wide (or wider or thinner) and may taper over the length or for example only over the last 5 mm (or other distance) of the length.

Alternative swab tubes and transition alternatives where the breaking of the tube is made may be like those alternatives described in either of U.S. Pat. Nos. 4,952,204 or 6,406,451 or in other patents or other publications or otherwise available means which may provide for a sealed enclosure with a transition allowing for breaking and opening for use as described herein.

Though cotton swabs may yet be used herewith and herein, often preferred may be foam tips used for the applicator. Cotton may not be very absorbent with oral care compositions (as for example in unit dose situations where a cotton tip may hold an approximate 0.25 ml of fluid vs. a foam tip which may hold a unit dose of 0.5 or 0.6 ml) and/or may degrade or break down in the presence of such materials (often of either a relatively alkaline or relatively acidic nature). A foam of the swab-like tip on the other hand hereof may preferably be of a polymer or polyester type which is resistant to degradation in the presence of the oral compositions described herein (whether alkaline or acidic) as well as any others which might be used herewith. In a variety of embodiments, the foam is of an open cell type, and in some embodiments has an inner resilient layer, and an outer softer layer. The cells in some instances may be of about 0.3 mm or of a size selected from about 0.3mm up to about 1 mm. In some embodiments, the foam has an abrasive quality for breaking plaque and debris from the teeth. Thus in some embodiments the cells of the foam may provide a scrubbing or scratchy surface which may be useful in applying a tooth composition wherein the user may not have first brushed their teeth. A foam tip may be straight, flat, rectangular, tapered, conical, cylindrical, round or rectangular or other straight cylinder shape or other shape as may be desired or may be useful herein or herewith. One or more undulations, ridges or other tooth appropriate projections may also/alternatively be provided.

Thus, it can be seen that the present invention provides a novel unit, including a swab and a substance contained within a plastic sleeve, and a sleeve and swab assembly for producing the same, which is neat and convenient to handle and use, and is relatively facile, simple and inexpensive to produce. The sleeve provides an enclosure that is secure, but nevertheless readily opened by manual force, and it also provides an integral element for shielding the user's hand from the contained substance and for curbing contact with the area being treated; in addition, its construction affords a secure and natural-feeling grip for manipulation of the assembled swab. Moreover, a foam tip may be enclosed for beneficial use with and/or for the application of oral care products as described below.

For example, some such oral care products which may be used herewith include tooth whitening compositions, and/or compositions which may be used in or with a tooth whitening process. Herefor it may be noted that many oral care compositions, for example, tooth whitening compositions include at least one peroxide compound to create a tooth whitening composition. The peroxide may be hydrogen peroxide (H₂O₂) or it may be one or more of other peroxides, for example, metal-ion-free peroxide compounds including urea peroxide (carbamide peroxide), salts of peroxides formed from the alkali and alkaline earth metals (e.g., calcium peroxide), glyceryl peroxide, benzoyl peroxide, and other organic peroxides. The peroxide may be a mixture of peroxides, for example, hydrogen peroxide and carbamide peroxide, or calcium peroxide with either or both hydrogen peroxide and carbamide peroxide.

Organic molecules, for example, chromagens, are often involved in the stains in discolored teeth. Carbon double bonds in organic molecules act as pigments. Chemically, peroxides give up a free radical oxygen atom when activated by an appropriate light source or chemical compound. Once released in the vicinity of teeth, the free radical oxygen atom attacks the carbon-carbon bonding structure of the organic molecule producing the stain. The offending molecule is oxidized and the oxygen is reduced. When there is an excess of hydroxy anion (OH⁻) present, the proton (H⁺) ion is abstracted from the peroxide. Once the peroxide is missing the proton that it gave to the hydroxy ion, the peroxide molecule must give up a free radical oxygen. Thus, the reaction allowing release of stain-removing oxygen can be driven chemically.

The amount of whitening obtained during tooth bleaching with peroxide compositions is generally dependent upon: (1) the length of time the teeth are in contact with the whitening agent; (2) the number and/or length of periods (e.g., hours and/or days) the treatment is carried out; (3) the susceptibility of the teeth to the bleaching agent; and (4) the concentration of active peroxide. For maximum whitening, a long treatment time with a highly concentrated bleaching composition has generally been recommended.

Chemical reactions are often affected by the relative acidity or alkalinity of the solution or environment in which the reaction occurs. Acidity and alkalinity are measured in terms of the relative presence or absence of hydrogen ions (H⁺), which was originally termed the “power of Hydrogen” or “pH.” The measure of pH is indicated as a number on a logarithmic scale, wherein a value of 7 represents neutrality, lower numbers indicate increasing acidity, and higher numbers indicate increasing alkalinity. Each unit of change on the pH scale is the negative logarithm of the effective hydrogen ion concentration or hydrogen ion activity in gram equivalents per liter of the solution and thus represents a tenfold change in acidity or alkalinity.

The liberation of free radical oxygen from a peroxide to effect stain removal can be performed by increasing the energy level of the peroxide molecule by adding energy to it or by chemically pushing the peroxide solution to a basic pH number. However, hydrogen peroxide in most tooth whitening compounds is generally carried in a slightly acidic solution in order to stabilize the peroxide before application. Thus, the normal application of a standard hydrogen peroxide whitening compound does not occur in a favorable reaction environment. Contrarily, an effective, biologically compatible environment for bleaching with hydrogen peroxide is at a slightly basic pH of between approximately 8.5 and 9.5, with a pH of about 8.8 being optimal. Biologic compatibility refers to a pH level that, while providing a catalytic benefit to the peroxide bleaching reaction, does not cause damage to oral tissues surrounding the dentition.

Some compositions may be provided for creating this alkaline environment for activating peroxide whiteners and accelerating the formation of free radicals from the peroxide to effect the oxidation of organic molecules causing staining of the dentition. In one embodiment, an enhancing composition is provided for advance application to the dentition before the application of any whitening compound, as a sort of pre-treatment. The primary components of such an enhancing composition may be water, which functions primarily as a carrier or solvent, and a base compound. One exemplary base that may be used is potassium hydroxide (KOH), which easily dissolves in water with much heat to form a strongly alkaline liquid. The dissolution of KOH in water also generates substantial heat, which may be conducive to the dissolution of additional ingredients in the enhancing composition. Other basic compounds may alternatively be used to create the alkalinity of the enhancing composition.

Enhancing compositions according to the present invention may further include a surfactant. Suitable surfactants may be anionic, nonionic, amphoteric, zwitterionic, cationic, and mixtures thereof. Anionic surfactants include, but are not limited to water-soluble salts of alkyl sulfates having from 8 to 20 carbon atoms in the alkyl radical (e.g., sodium alkyl sulfate), water-soluble salts of sulfonated monoglycerides of fatty acids having from 8 to 20 carbon atoms, and mixtures thereof. Examples of anionic surfactants include sodium lauryl sulfate, sodium coconut monoglyceride sulfonates, phospholipids, sarcosinates such as sodium lauryl sarcosinate, taurates, sodium lauryl sulfoacetate, sodium lauroyl isethionate, sodium laureth carboxylate, and sodium dodecyl benzenesulfonate. Many of these anionic surfactants are disclosed in U.S. Pat. No. 3,959,458, which is hereby incorporated herein by reference in its entirety.

Nonionic surfactants may include, but are not limited to, compounds comprising hydrophilic (having an affinity for water) and hydrophobic components (lacking an affinity for water). These surfactants may be produced by the condensation of alkylene oxide groups, which are hydrophilic in nature, with an organic hydrophobic compound, which may be aliphatic or alkyl-aromatic in nature. Examples of suitable nonionic surfactants include low viscosity poloxamers, e.g., poloxamer 188 (under trade name Pluronic), low viscosity hydroxyethyl cellulose, polysorbates, polyoxyethylene sorbitan esters (under trade name Tweens), fatty alcohol ethoxylates, polyethylene oxide condensates of alkyl phenols, products derived from the condensation of ethylene oxide with the reaction product of propylene oxide and ethylene diamine, ethylene oxide condensates of aliphatic alcohols, long chain tertiary amine oxides, long chain tertiary phosphine oxides, long chain dialkyl sulfoxides, and mixtures thereof.

Amphoteric surfactants may include, but are not limited to, derivatives of aliphatic secondary and tertiary amines in which the aliphatic component may be a straight chain or branched. One of the aliphatic substituents may contain from about 8 to about 18 carbon atoms and one may contain an anionic water-solubilizing group, e.g., carboxylate, sulfonate, sulfate, phosphate, phosphonate, betaines (e.g., cocamidopropyl betaine), and mixtures thereof. Many of these nonionic and amphoteric surfactants are disclosed in U.S. Pat. No. 4,051,234, which is hereby incorporated herein by reference in its entirety.

Any asymmetrical molecule dissolved in water will make at least a weak surfactant. Such weak surfactants may not normally be effective foaming agents, but the effectiveness can be improved if an alternatively available foaming dispenser is used. Asymmetrical molecules as contemplated herein may include those that contain a hydrophilic and a hydrophobic segment. One end of the molecule is thus polar in nature and dissolves in water, while the other end is nonpolar in nature, avoids water, and dissolves in oil and other nonpolar compounds. When in water, their polar ends of these surfactant molecules are oriented toward the water molecules, while the non-polar ends attract non-polar molecules. The non-polar ends of the surfactant molecules lift stain molecules from the tooth surface by loosening the molecules, breaking them up, and holding them onto the asymmetric molecules, allowing them to be washed away with the water.

Surfactants may also be included in the oral care enhancing compositions in solid form. Solid form surfactants may include, for example, sodium carbonate anhydrous, sodium bicarbonate, potassium iodide, and mixtures thereof. Exemplary surfactants may also include at least some difunctional block copolymer surfactants, e.g., those having terminal groups of primary hydroxyl groups, and groups comprising a hydrophobic and a hydrophilic segment. Examples include Pluronic F68, Pluronic F88, and mixtures thereof. The amount of a surfactant used in an oral care enhancing composition may be in a range approximated by the amount given in the below example, TABLE 1.

The enhancing composition may further include ingredients for affecting the taste and feel of the enhancing composition by a user. For example, flavor oils such as peppermint oil or cinnamon oil may be included to provide a pleasing flavor to the enhancing composition. Sodium saccharin, sucralose, aspartame, or other sweetening agents may be used to enhance the flavor. Sodium citrate may be added as an anticoagulant to improve the feel of the enhancing composition in the mouth. It may also enhance the effectiveness of any surfactant by preventing interference from any calcium ions present.

The enhancing composition may further include a peroxide as used in the whitening compound, for example but not limited to, hydrogen peroxide. Other peroxygen containing or generating compounds may also be used herewith. In many examples, for increasing peroxide stability during storage, a 3% di-sodium EDTA may be added to the enhancing composition. Alternatively, stability may be enhanced by refrigeration or otherwise storing the product in a dark, cool, dry place.

The composition of the present invention can also include other active ingredients, such as peroxide photo-activators. The addition of peroxide photo-activators can also increase the photobleaching efficiency of the foamable compositions of the present invention. Suitable peroxide photo-activators include those with lower oxidative state transition metal salt. The metal salt may catalyze the bleaching action of the peroxide to produce faster effective bleaching at lower peroxide concentrations. The preferred transition metals are those of lower atomic numbers including lower atomic number transition metals such as those ranging from atomic number 21 to 30. Also, those with lower oxidative states may be more preferred, including, e.g., Iron(II), manganese(II), cobalt(II), copper(II) and mixtures thereof, and most preferably Iron(II), as in a ferrous gluconate. When used, only a very small amount of the transition metal salt is needed, for example, from about 0.01% by weight to about 4% by weight, further for example, from about 0.03% by weight to about 2% by weight, and even further for example, from about 0.04% to about 1% by weight. The peroxide photo-activator can also include alkali salts such as potassium iodide, potassium chloride, sodium iodine, sodium chloride and combinations thereof.

Amorphous calcium compounds such as amorphous calcium phosphate (ACP), amorphous calcium phosphate fluoride (ACPF) and amorphous calcium carbonate phosphate (ACCP) amorphous calcium carbonate phosphate (ACCP), and amorphous calcium carbonate phosphate fluoride (ACCPF) can be used in re-mineralizing teeth. These amorphous compounds are disclosed in U.S. Pat. Nos. 5,037,639, 5,268,167, 5,437,857, 5,562,895, 6,000,341, and 6,056,930, the disclosure of each of which hereby being incorporated by reference in its entirety.

In addition to or as an alternative to amorphous calcium compounds, amorphous strontium compounds such as amorphous strontium phosphate (ASP), amorphous strontium phosphate fluoride (ASPF), amorphous strontium calcium phosphate (ASCP), amorphous strontium calcium carbonate phosphate (ASCCP), amorphous strontium carbonate phosphate fluoride (ASCPF) and amorphous strontium calcium carbonate phosphate fluoride (ASCCPF) may be included for use in re-mineralization, as noted above. Such compounds are disclosed in U.S. Pat. No. 5,534,244, the content of which hereby incorporated by reference in its entirety.

For example, the whitening compound may include a source of phosphate and the second component may include a source of calcium or strontium. For example, the source of phosphate in the first component includes monosodium phosphate (NAH₂PO₄), disodium phosphate, tetrapotassium pyrophosphate and relatives thereof. As introduced above, the whitening component may include a source of calcium or strontium, which combines with phosphate to form the various amorphous calcium and/or strontium phosphates. The source of phosphate may be, for example, present in an amount of from about 0.2% to about 5% by weight. The source of calcium, strontium, or combinations thereof may include a calcium salt, a strontium salt, and thereof, further for example, a calcium salt such as calcium nitrate, in an amount of from about 0.25% by weight to about 1.5% by weight. The source of phosphate and the source of calcium, strontium or mixture can combine to form calcium phosphate. When applied to the teeth, the calcium phosphate can precipitate onto the surface of the teeth where it may be incorporated into hydroxyapatite, assisting in remineralization of the tooth enamel, as discussed in U.S. Pat. Nos. 5,037,639; 5,268,167; 5,460,803; 5,534,244; 5,562,895; 6,000,341; and 6,056,930 noted above.

In practice, it may in some embodiments be preferred to include as much phosphate as possible, as the phosphate salt further acts to adjust the pH of the first component. The pH of the system is from, for example, about 5 to about 8, or for a further example, from about 5.5 to about 6.5.

Note also, the fluoride-containing amorphous compounds described here may also be used in fluoridating teeth. Otherwise, as mentioned, fluorides may be added separately and then, many, if not all of the above amorphous compounds or solutions which form the amorphous compounds, when applied either onto or into dental tissue, particularly in the presence of fluoride, may operate to promote fluoridation. Such fluoridation or other mineralization may serve to assist in prevention and/or repair of dental weaknesses such as dental caries, exposed roots and dentin sensitivity.

The enhancing composition of the present invention can also include other active ingredients, such as de-sensitizing agents and/or antimicrobial or antibacterial agents. Even with improved efficiency and shorter treatment time, some patients may still experience sensitivity from tooth whitening compositions. Inclusion of desensitizing agents in the enhancing composition allows time for desensitization of the oral tissue before the application of the whitening compound. Suitable desensitizing agents can include Eugenol and/or alkali nitrates such as potassium nitrate, sodium nitrate, and lithium nitrate and other potassium salts such as potassium chloride and potassium bicarbonate. The desensitizing agent may make up to about 3% to 5% percent by weight of the enhancing composition. Eugenol may also act as an antimicrobial or antibacterial agent.

Further additives may include calcium nitrate and/or sodium mono and/or dibasic hydrate. These compounds may be added to lower the viscosity of the enhancing composition and provide a composition that has greater ability to penetrate recesses and interstices of the dentition. Such additives may also improve the stability of the enhancing composition. Potassium nitrate may alternatively and/or additionally be added to achieve desired viscosity effects.

In addition, optional additives including emulsifiers, flavorings, coloring agents, anti-plaque agents, anti-staining compounds, excipients such as emollients, preservatives, other types of stabilizers such as antioxidants, chelating agents, tonicity modifiers (e.g., sodium chloride, manitol, sorbitol, or glucose), spreading agents, pH adjusting agents and water soluble lubricants, e.g., propylene glycol, glycerol, or polyethylene glycol may be included in the enhancing composition. The concentration of each may easily be determined by a person skilled in the art. Lecithin, a natural emulsifier found in soy and other plants, and gum arabic, which comes from the sap of certain species of acacia trees, can be added for use as an emulsifier, dispersant, and/or wetting agent. Suitable preservatives may include benzalkonium chloride, parabens, chlorhexidine acetate, chlorhexidine gluconate, sorbic acid, potassium sorbitol, chlorbutanol, and phenoxyethanol. Suitable emollients such as those used for topical applications are, for example, di-n-octyl ether, fatty alcohol polyalkylene glycol ether, 2-ethylhexyl palmitate, and isopropyl fatty acid esters.

An exemplary formula for an enhancing composition hereof is presented in Table 1 below. Water is used as the primary carrier and solvent for the remaining ingredients. Potassium hydroxide is incorporated as the peroxide activator and pH modifier. Other optional ingredients which may provide certain functionalities may include tartaric acid to adjust the final pH of the enhancing composition to a biologically compatible level and hydrogen peroxide to initiate the whitening process. Several non-active ingredients include Pluronic F68 as a gelling agent, sodium laurel sulfate as a stain remover, sodium saccharin as a sweetener, sodium citrate for improved oral sensation, peppermint oil for flavor and scent, ethanol as an antibacterial agent, and a color additive for visual interest.

TABLE 1

| | | | Chemical/ | | |
|---|---|---|---|---|---|
| | | | IUPAC | | |
| | | | “real | | |
| Ingredient | Amount | | name” | Source | Purpose |
| water (H₂O) | 80 | ml | | N/A | carrier/solvent |
| potassium | 0.1 | g | Same | Spectrum | peroxide |
| hydroxide | | | | Chemical | activator/pH |
| (KOH) | | | | | modifier |
| Pluronic F68 | 0.5 | g | poloxamer | BASF | gelling agent |
| | | | 188 | | |
| sodium laurel | 0.5 | g | Same | | stain remover |
| sulfate (SLS) | | | | | |
| sodium saccharin | 0.3 | g | Same | | sweetener |
| sodium citrate | 0.7 | g | Same | | oral sensation |
| (Na₃C₆H₅O₇) | | | | | |
| Hydrogen | 6.7 | g | Same | Autofina | bleaching agent |
| peroxide (H₂O₂) | | | | | |
| (30%) | | | | | |
| peppermint oil | 0.3 | g | Same | S & S | flavor, scent, |
| | | | | Flavors | stabilizer |
| ethanol | 8.6 | g | Same | Spectrum | anti-bacterial |
| (C₂H₅OH) | | | | Chemical | |
| red color | 2 | drops | Same | Warner | colorant |
| | | | | Jenkins | |
| tartaric acid | 0.1 | g | Same | Spectrum | pH modifier |
| (C₄H₆O₆) | | | | Chemical | |

The ingredients of Table 1 including the exemplary enhancing composition may be mixed as described here. Initially, approximately 0.1 g of potassium hydroxide is completely dissolved in 60 ml of water. The dissolution of potassium hydroxide is an exothermic process that heats the solution. Next, approximately 0.5 g of poloxamer 188 is dissolved in the H₂O—KOH mixture. The generation of heat may be advantageous because heat may be beneficial for the dissolution of the poloxamer 188. Application of additional heat to the mixture may assist in completely dissolving the poloxamer 188. The mixture of H₂O, KOH, and poloxamer 188, which may be referred to as Mixture 1, is set aside.

A second mixture, Mixture 2, is prepared by dissolving approximately 0.3 g of sodium saccharin in 20 ml of water. Mixture 2 is completed by dissolving approximately 0.7 g of sodium citrate into the water-sodium saccharin solution. Mixture 1 is then combined with Mixture 2. Next, approximately 6.7 g of 30% hydrogen peroxide solution is slowly introduced to the combination of Mixture 1 and Mixture 2 to form Mixture 3. Mixture 3 may then be set aside.

Another mixture, Mixture 4, is created by dissolving approximately 0.3 g of peppermint oil in approximately 8.6 g of ethanol. Several drops of a coloring additive, for example, food coloring, may be added to Mixture 4 to provide visual interest to the enhancing composition. In the ingredients depicted in Table 1, approximately two drops of red coloring may be added to Mixture 4.

Next, Mixture 4 is slowly added to Mixture 3 to form Mixture 5. Finally, approximately 0.1 g of tartaric acid may be added to Mixture 5 to adjust the basic pH of Mixture 5 downward to a biologically compatible level, for example, between about 8.5 and 9.5, with a target pH of about 8.8. The mixture of the ingredients in Table 1 thus results in a 100 ml volume of an exemplary enhancing composition for pretreatment of dentition before application of a tooth whitening composition. The increase in pH created by the enhancing composition enhances the effectiveness of the tooth whitening compound. Note, unit doses of such a composition may be on the order of about 0.5 or about 0.6 ml per use. The swab tubes hereof may desirably contain such an amount, indeed, a foam tip may absorb such an amount.

Although certain steps for combining the ingredients identified in Table 1 are indicated in the discussion above, it should be recognized that additional or alternative ingredients described above may also be included or substituted in the enhancing composition. Further, these steps are merely exemplary and other variations for mixing ingredients of the enhancing composition are possible and contemplated.

The enhancing composition may be applied to a user's dentition in any of a variety of ways. For example, if the enhancing composition has a low viscosity, the enhancing composition may be provided in the form of a mouth rinse. At a higher viscosity, for example, in the form of a gel or paste, the enhancing composition may be applied with a brush or a swab. The enhancing composition may be in the form of a tooth paste and applied with a standard tooth brush. The enhancing composition may also be applied with a brush more closely resembling a paint brush.

As introduced above, in some preferred embodiments hereof, the enhancing composition would be applied with a swab (e.g., the enhancing composition is a fluid or a gel), the swab may in many cases be formed of a foam material rather than other materials. Foam may be more structurally sound and uniformly absorptive as compared to cotton swabs or other materials. Foam also is resistant to breaking down and does not permanently deform. A foam tip may be straight, flat, rectangular, tapered, conical, cylindrical, round or rectangular or other straight cylinder shape or other shape as may be desired or may be useful herein or herewith. Moreover, the applicator may be of a type where the foam tip provides one of undulations, ribs or other projections on the surface, such projections perhaps providing any of a number of functionalities including for example, giving a shape similar to a tooth brush for agitating the swab and oral composition or for cleaning or otherwise reaching in between teeth. The foam, if used, may be of nylon or rayon (which is the same as many tooth brush bristles conventionally are made from). Also, the cells, or micells, or the walls of the foam cells of the foam may present with a thickness like or such as very thin fibers (such as toothbrush bristles) on the order of about 0.2 mm to about 0.5 mm (0.3 may be a preferred width in some cases) which is the width of many bristles. Smaller may provide a smoother, softer foam with attendant softness in use which may be useful in pure application of a composition, whereas larger may provide more roughness or abrasiveness for desirable cleaning and/or agitation in some cases along with composition delivery. The flock may be sufficient for either or both of providing an abrasive tooth-brushing quality or for retaining a dentifrice or tooth whitening agent or both.

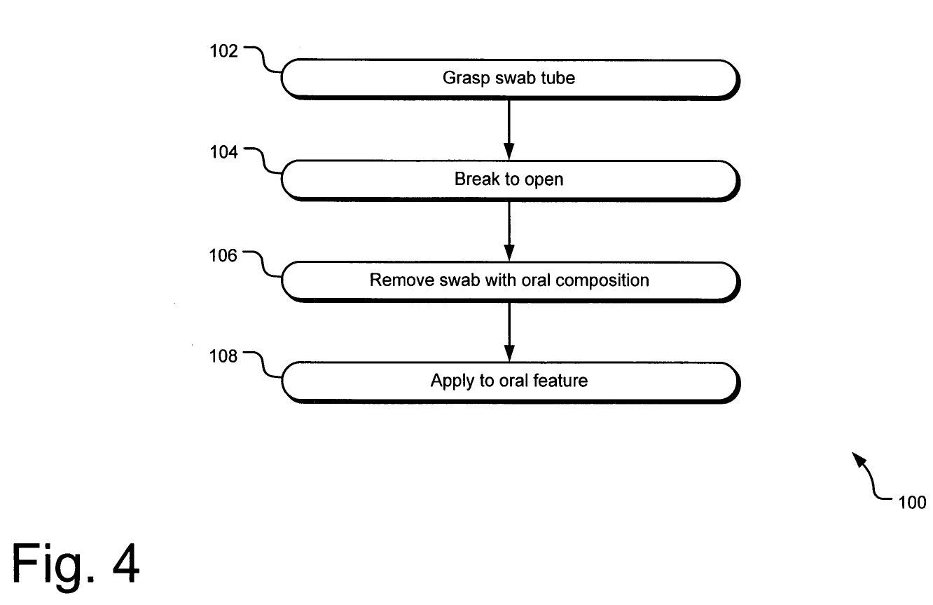

In use, a pre-packaged amount of the accelerator, enhancer or activator composition described hereabove may be disposed in a tube and swab unit such as those shown in FIGS. 1-3. An amount of between about 0.25 and 1.1 ml and typically of about 0.6 ml will be so disposed in a tube such as that of FIGS. 1-3. A typical amount of about 0.5 or about 0.6 ml would often be a unit dose of such a composition. In some embodiments, the foam tip of such a combination may be absorbent sufficiently to contain and hold absorbed therein about 0.6 ml of an active composition such as the accelerator or activator mixture described. In such a situation, this may provide for containing on/in the tip a sufficient amount of composition for application to all of a user's teeth without requisite for re-dipping the applicator into the tube (dip once). In any case, then, in use according to the method 100 as shown in FIG. 4, a user may first grasp the swab tube (operation 102), then break or snap open the swab tube (operation 104) and remove the swab from the tube (operation 106) for ultimate application of the composition thereon or absorbed therein to the oral feature (operation 108) as to a tooth or to the teeth. In this way, a tooth whitening pre-treatment composition as described herein may be applied to the teeth. Note, a painting on of the composition may be performed and/or a brushing action with abrasive scrubbing may take place to help remove plaque and/or debris from the teeth for maximizing application of the composition to the teeth. Note, if a unit dose of oral care composition is included in the swab tube, and/or on/in the foam tip thereof (if a foam tip is used), this will enhance convenience in use by limiting the number of dips necessary into the tube. A single unit dosage absorbed or absorbable into a foam tip would mean that no dips would be necessary after removal of the swab from the tube.

In addition or as an alternative to the enhancing composition, a post-whitening rinse composition may also be used as part of a complete tooth whitening process, and a separate applicator of a swab in tube type such as described herein may be used therewith. The primary purpose of the post-whitening rinse compound may be to return the pH within the user's mouth after a bleaching application to neutral. Moreover, a bleaching or whitening composition may also include or be included within a swab-tube hereof. An exemplary bleaching composition is described in copending U.S. patent application Ser. No. ______, entitled “Oral care compositions and methods,” which is hereby incorporated herein by reference. Note, for two-component whiteners, the two components may be maintained separately prior to use and combined just prior to use, and in such cases, two separate swab tubes may be used, one each for each of the two components, the swabs of either or both tubes being used for the mixing and/or ultimate application of the mixture to the teeth. Any other commercially available bleaching or whitening composition may likewise be used in conjunction with the enhancing composition and rinse composition. An exemplary post-rinse composition may be slightly acidic, for example, about 5.5 pH, to reduce the pH from the more basic level of between 8.5 and 9.5 created by the enhancing composition to neutral pH of about 7.

An exemplary tooth whitening process may include one or more of the steps of enhancing, whitening, and/or rinsing. First, an alkaline enhancing composition according to the description herein is applied to a user's dentition. As indicated above, application of the enhancing composition may be by the foam (or a cotton) swab hereof. The enhancing composition is left on the user's dentition for a first period of time. For example, if the enhancing composition is for over-the-counter consumer use, the application period may be on the order of about a second up to approximately a few minutes. Alternatively, if the enhancing composition is of a greater pH than a consumer composition and is applied by a dental practitioner in a clinical setting, the application period may be of an even shorter period of time.

Once the enhancing period expires, though this may be substantially immediate, a whitening composition may then be applied to the user's dentition. Again, the whitener or bleaching agent may be any of a myriad of available products available over-the-counter or for clinical application, e.g., gels and pastes for brush-on or tray application and adhesive strips. A foam (or cotton) swab hereof may be used therefor. The whitening composition is left on the user's dentition for a second period of time, which varies according to the whitening product used. The second time period may be anywhere between several minutes, several hours, or overnight. Finally, an acidic rinse composition according to the description herein may be applied to the user's dentition for a third period of time. A further separate swab tube hereof (with foam or cotton tip) may be used herefor. The rinse composition operates to neutralize the basic pH environment created in the user's mouth by the enhancing composition to increase the effectiveness of the whitening composition. The rinse composition may be applied over a period of about a second or a few seconds up to approximately a few minutes to ensure effective neutralization.

It may first be noted that either of these enhancers, i.e., a pre-whitening activator and/or a post-whitening activator, may be used, manufactured and/or sold completely separately one from another, and indeed may be distributed and/or used apart from the whitening composition(s). In some instances, a user may use only a pre-whitening activator and then a whitening composition with or without a post-whitening activator; and in other instances, a user may use a whitening agent and a post-whitening activator without a pre-whitening activator. Even so, it may be preferred to use all three in order; namely, a pre-whitening activator, then, a whitening agent or agents (see below), and finally a post-whitening activator as described hereinabove. In such a case, the combination may be referred to as a three-component system (pre-whitening, whitening, and post-whitening). In some other instances, the whitening composition/system itself may occur in one or two or more components as described in the co-pending patent applications Ser. Nos. ______, and the overall system may then reflect the total number of components. For example, when the whitening system itself includes two components, then, a system hereof may be a four-component system; namely, a pre-whitening component, whitening in two component parts, and a post-whitening component. The method of use hereof would be as described in FIG. 2 with the modification of including the mixing of the two parts of the whitening composition prior to or during application thereof to the dental surfaces, after the initial pre-whitening enhancing application and before the post-whitening enhancing application.

In some embodiments, a foam applicator hereof may be used without any added fluid composition and may thus act not as an applicator so much as a tooth brush, particularly in a simply transportable style with retention of sterility and/or hygienics, i.e., conveniently carried in an otherwise unopened and thus uncontaminated tube. The receptacle end of the tube is thus only a receptacle of the foam tip and a protector therefor until use. Thus, a dry applicator may be used alone in brushing the teeth, or may have applied thereto a dentifrice or toothpaste or whitening composition (activator, whitening or post-rinse) other material for use in oral care. Similarly or alternatively, a dentifrice or other oral care material may be dried on the foam tip and applied dry to the mouth or oral feature. In some cases, the saliva in the mouth can be used to wet and thus activate the dried-on material. In such cases the dentifrice may be originally disposed in a carrier such as an alcohol which dissipates rapidly in air, perhaps upon application of a stream of air, e.g., a stream of heated air. The flock of the foam need only be sufficient to retain the dentifrice. Note however, that a dentifrice having real active ingredients may be used on and/or retained within such a device, not being merely a starch substance.

The above specification, examples and data provide a complete description of the structure, process, and use of exemplary embodiments of the invention. Although various embodiments of this invention have been described above with a certain degree of particularity, or with reference to one or more individual embodiments, those skilled in the art could make numerous alterations to the disclosed embodiments without departing from the spirit or scope of this invention. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

1. A swab tube for use with an oral care composition for oral use; the swab tube unit including:
a swab having an elongated stick with an applicator/brush element at one end thereof;
and an elongated hollow sleeve assembled with said swab disposed therein, the hollow sleeve having a handle portion at one end, a receptacle portion at the other end, and a transition portion therebetween, said handle portion of the sleeve holding said stick, said receptacle portion being of substantially larger cross section than said handle portion and adapted to receive an oral care composition therein, and the adjacent components of said receptacle and transition portions at the intersection therebetween cooperatively constituting means for creating a break open means in said sleeve to provide access to said swab for use in one of application of an oral care composition.

2. A swab tube according to claim 1 wherein one of an oral care composition and no oral care composition is pre-sealed therewithin.

3. A swab tube according to claim 1 wherein the applicator is one of a cotton swab and a foam tip.

4. A swab tube according to claim 1 wherein the applicator is a foam tip of a polymeric type.

5. A swab tube according to claim 1 wherein the applicator is a foam tip of an open cell type.

6. A swab tube according to claim 1 wherein the applicator is a foam tip of a type with a strong inner layer.

7. A swab tube according to claim 1 wherein the applicator is a foam tip of a type with a softer outer layer.

8. A swab tube according to claim 1 wherein the applicator is a foam tip of a type with an abrasive layer.

9. A swab tube according to claim 1 wherein the applicator is a foam tip of a type with a tapering tip.

10. A swab tube according to claim 1 wherein the applicator is a foam tip of a type with one of undulations, ribs or one or more other projections on the surface.

11. A swab tube according to claim 1 wherein an oral care composition is pre-sealed therewithin and the oral care composition is one of fluid, powder or dried-on.

12. A swab tube according to claim 1 wherein said sleeve is integrally formed as a single piece from a relatively rigid plastic material that is manually compressible and severable in thin sections.

13-19. (canceled)

20. A swab tube unit for use with one of an oral enhancing and an oral rinse composition for oral use in one of in advance of application of a tooth whitening composition and for use post application of a tooth whitening composition, the oral enhancing composition comprising:
a solvent; and
a base compound dissolved in the solvent to form an alkaline solution;
the enhancing composition comprising
a solvent, and
an acid compound dissolved in the solvent to form an acidic solution;
and the swab tube unit including:
a swab having an elongated stick with an applicator element at one end thereof;
and an elongated hollow sleeve assembled with said swab disposed therein, the hollow sleeve having a handle portion at one end, a receptacle portion at the other end, and a transition portion therebetween, said handle portion of the sleeve holding said stick, said receptacle portion being of substantially larger cross section than said handle portion and disposed to receive an oral care composition, and the adjacent components of said receptacle and transition portions at the intersection therebetween cooperatively constituting means for creating a break open means in said sleeve to provide access to said swab for use in application of the oral care composition.

21 -34. (canceled)

35. A method of using the swab tube unit of claim 20 for oral use as a pre-treatment of a tooth whitening composition, the method comprising
applying the enhancing compound to a user's dentition; and
applying the tooth whitening composition.

36. The method of claim 35, wherein the step of applying further comprises rinsing the enhancing compound within an oral cavity containing the user's dentition.

37. The method of claim 35, wherein the step of applying further comprises using the applicator to one of swab, agitate and brush the enhancing compound on the user's dentition.

38. A method of using a foam-tipped oral care device on a user's oral feature, the method comprising:
grasping a pre-sealed swab tube having a foam-tipped oral care device pre-disposed therein;
breaking open the pre-sealed swab tube;
removing the foam-tipped device from the swab tube;
applying the foam-tipped device to the oral feature.

39. A method according to claim 38 wherein the foam-tipped device has an oral care composition thereon or absorbed therein, and the applying step includes applying the oral care composition to the oral feature.

40. A method according to claim 39 wherein the oral feature is one of a tooth or teeth.

41. A method according to claim 38 wherein the oral care composition is a tooth whitening agent.

42. (canceled)
